(19) United States
(12) Patent Application Publication
(10) Pub. No.: US 2016/0291816 A1
(43) Pub. Date: Oct. 6, 2016

(54) GRAPHICAL USER INTERFACE FOR TOUCH DISPLAY

(71) Applicant: Caterpillar Inc., Peoria, IL (US)

(72) Inventors: Joseph Allen Thoreson, Dunlap, IL (US); Jeffrey Alan Brush, Dunlap, IL (US); Arnab Khound, Guwahati (IN); N. Ganesh Balaji, Coimbatore(DT) (IN)

(73) Assignee: Caterpillar Inc., Peoria, IL (US)

(21) Appl. No.: 15/182,326

(22) Filed: Jun. 14, 2016

(51) Int. Cl. G06F 3/0482; G06F 3/0481; G06F 3/0488

(52) U.S. Cl. CPC G06F 3/0482; G06F 3/04883; G06F 3/04817

(57) ABSTRACT

A graphical user interface for a touch display is provided. The graphical user interface includes a menu structure including a plurality of layers. The graphical user interface also includes a visual cue provided in association with the menu structure. The visual cue provides an indication of a current location of a user selection within the plurality of layers.

### TECHNICAL FIELD

The present disclosure relates to a touch display. More particularly, the present disclosure relates to a graphical user interface for the touch display.

### BACKGROUND

Touch display screens that are responsive to localized touch contact are well known. An interactive graphical user interface of the touch display screen presents data to a user based on selection by the user. The graphical user interface may accordingly include a nested menu structure that the user may have to navigate through. The graphical user interface may present corresponding data based on the selection of certain menu options by the user.

As the user navigates deeper into the menu structure, it may become difficult for the user to know a relative location of the displayed data within the menu structure. Since the user may be unaware of his location within the menu structure, navigating to other menu options may be cumbersome and confusing.

U.S. Published Application number 2014/0292685 describes an active feedback interface for a touch screen display that includes display of visual cues to indicate when and where the display was touched by a user. The visual cues change over a period of time in accordance with a particular active or inactive area of the touch screen contacted by a user finger.

### SUMMARY OF THE DISCLOSURE

In an aspect of the present disclosure, a graphical user interface for a touch display is provided. The graphical user interface includes a menu structure including a plurality of layers. The graphical user interface also includes a visual cue provided in association with the menu structure. The visual cue provides an indication of a current location of a user selection within the plurality of layers.

Other features and aspects of this disclosure will be apparent from the following description and the accompanying drawings.

### BRIEF DESCRIPTION OF THE DRAWINGS

FIG. 1 is a schematic representation of an exemplary graphical user interface having a menu structure, according to one embodiment of the present disclosure;

FIGS. 2 and 3 illustrate different stages of user navigation from one menu option to another menu option, according to one embodiment of the present disclosure; and

FIG. 4 is a flowchart of a method of navigation for the graphical user interface, according to one embodiment of the present disclosure.

### DETAILED DESCRIPTION

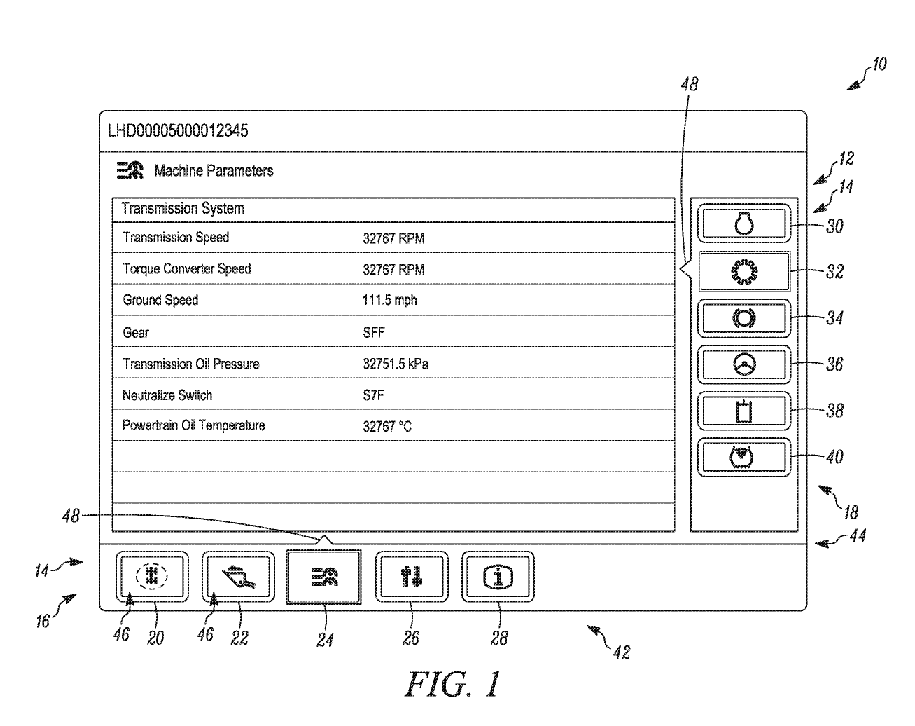

Referring to FIG. 1, an exemplary graphical user interface 10 is illustrated. The graphical user interface 10 is displayed on any touch screen device. In one embodiment, the touch screen device may be installed in an operator cabin of a machine. In another embodiment, the touch screen device may be provided at a remote control station. In yet another embodiment; the touch screen device may embody any handheld personal device. Alternatively, the touch screen device may be utilized in other environments not described herein.

The graphical user interface 10 displays data related to various parameters of the machine. Alternatively, content of the graphical user interface 10 may vary based on the application. The graphical user interface 10 includes a menu structure 12 having a number of layers 14. More specifically, the illustrated graphical user interface 10 has a nested menu structure 12 having two layers 14: a primary layer 16 and a secondary layer 18. The primary layer 16 has five menu options which are: “area isolation system” 20, “payload monitoring” 22, “machine parameters” 24, “settings” 26, and “information” 28. The secondary layer 18, corresponding to the “machine parameters” 24 of the primary layer 16, has six menu options which are: “engine parameters” 30, “transmission system” 32, “gear system” 34, “steering system” 36, hydraulic system” 38, and “tires” 40.

The design and layout of the primary and secondary layers 16, 18 of the menu structure 12 are exemplary and do not limit the scope of the present disclosure. The number of menu options available in the primary layer 16 may vary. Further, based on user selection of different menu options of the primary layer 16, the number of menu options in the secondary layer 18 may also vary. For example, the “settings” 26 menu option of the primary layer 16 may have corresponding four menu options in the secondary layer 18. In another example, the “information” 28 menu option of the primary layer 16 may not have any options in the secondary layer 18.

The present disclosure provides the graphical user interface 10 that displays all the distinct layers of the menu structure 12 at designated areas of the display. For example, the primary layer 16 is positioned and displayed at a first area 42 of the graphical user interface 10. The secondary layer 18 is displayed at a second area 44 of the graphical user interface 10. The location of the primary and secondary layers 16, 18 of the graphical user interface 10 illustrated in the accompanying figures is exemplary and may vary based on the application.

Further, in other embodiments, the menu structure 12 may also include a tertiary layer (not shown) corresponding to at least some of the menu options of the secondary layer 18. In this case, the tertiary layer may be displayed at a location adjacent to the secondary layer 18. Alternatively, the tertiary layer may be displayed at a side of the display opposite to that of the secondary layer 18. In some embodiments, the primary and secondary layers 16, 18 may be positioned adjacent to each other such that the secondary layer 18 builds off the primary layer 16 based on the user selection.

Referring to FIG. 1, the user has selected the “machine parameters” 24 of the primary layer 16 of the menu structure 12. Accordingly, the display of the secondary layer 18 of the menu structure 12 is based on the selected menu option of the primary layer 16. Hence, in the given situation, the “machine parameters” 24 menu option of the primary layer 16 has six corresponding menu options in the secondary layer 18 which are clearly visible on the display. In some situations, when the corresponding secondary layer 18 is not available for the selected menu option of the primary layer 16, the secondary layer 18 may not be displayed on the graphical user interface 10.

The menu options on the primary and secondary layers 16, 18 of the menu structure 12 are represented by appropriate symbols on interactive menu indications 46. These interactive menu indications 46 are clickable buttons on the graphical user interface 10. An appearance of the buttons may change based on user selection such that the user may easily be able to visually distinguish between the buttons that are selected and the buttons that are unselected. For example, the buttons that are unselected may appear in a three dimensional and clickable configuration, whereas the buttons that are currently selected by the user may appear grey in color with a flattened appearance. Based on the user selection, at any instant of time only one of the buttons of the primary layer 16 and all other layers 14 displayed on the graphical user interface 10 appear grey and flat indicating that the user has selected that given menu option.

According to the selection made by the user, the graphical user interface 10 displays relevant data or content pertinent to the selected menu options from the primary and/or secondary layers 16, 18. For example, if the user has selected “machine parameter” 24 menu option from the primary layer 16 and “transmission system” 32 menu option from the secondary layer 18, then the relevant data including transmission speed, torque converter speed, ground speed, gear, transmission oil pressure, neutralize switch, and powertrain oil temperature is displayed on the graphical user interface 10.

Additionally, the graphical user interface 10 includes visual cues 48 associated with the menu structure 12. The visual cue 48 provides a visual and intuitive indication to the user of the current location of the user selections within the menu structure 12. The visual cue 48 is embodied as a triangular shaped pointer. Alternatively, the visual cue 48 may include a hemi-spherical shaped icon. The visual cue 48 is positioned on the graphical user interface 10 in such a manner that the visual cue 48 ties the displayed data with the selected menu options of the primary and/or secondary layers 16, 18 of the menu structure 12.

For example, since the user selected the “machine parameter” 24 menu option of the primary layer 16 and the “transmission system” 32 menu option of the secondary layer 18, resulting in the current display of the relevant data on the graphical user interface 10, the visual cues 48 provided in association with the respective selected menu options of the primary and secondary layers 16, 18 indicate the user's current location within the menu structure 12. The number and location of the visual cue 48 provided on the graphical user interface 10 may vary based on the number of displayed layers 14 of the menu structure 12 and the selection of the menu options made by the user.

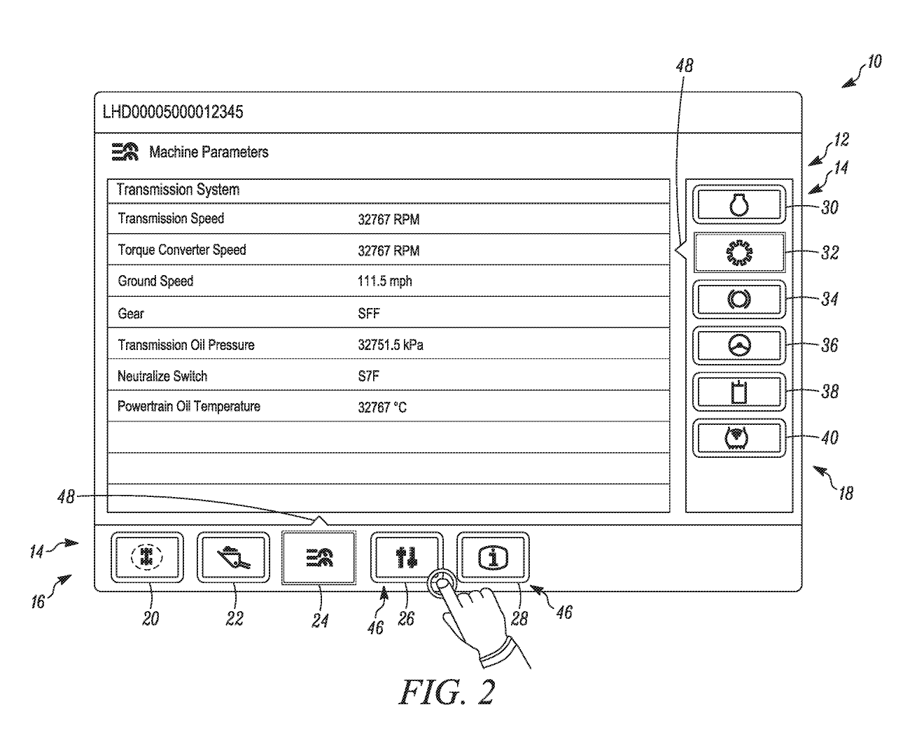

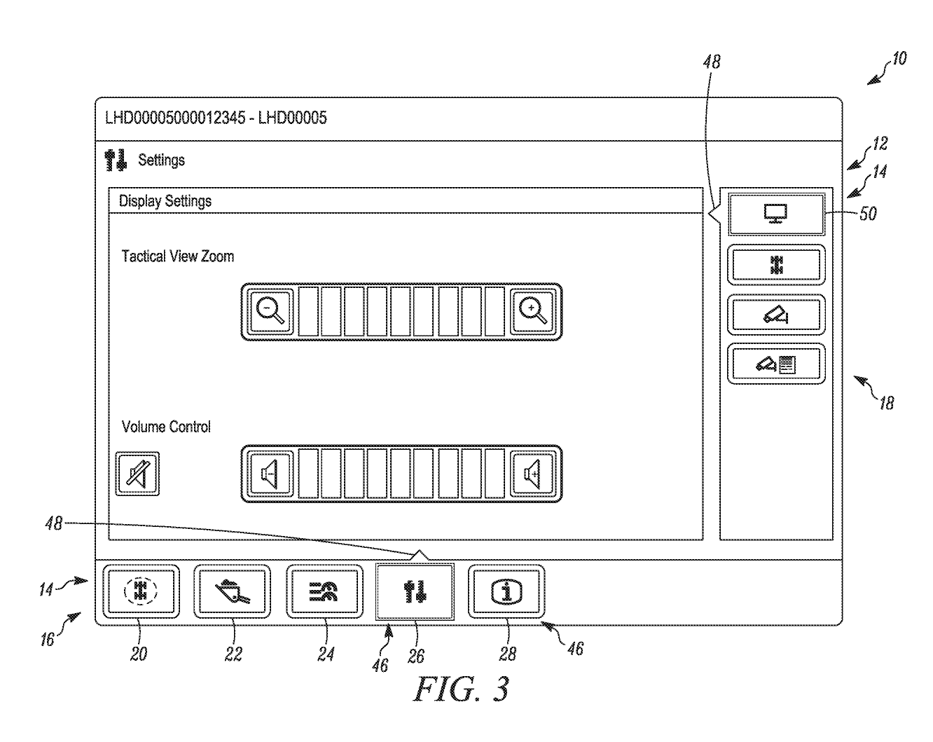

FIGS. 2 and 3 illustrate an exemplary navigation from a current display to another display of the graphical user interface 10. When the user taps on the “settings” 26 menu option of the primary layer 16, the interactive menu indication 46 changes its appearance to indicate user selection thereof. For example, when the user clicks or taps on the button of the “settings” 26 menu option with his fingertip, the button may turn from light grey to dark grey in color to indicate that the user has selected the given menu option.

Further, upon the removal of the user's finger from the button, the appearance of the newly selected menu option “settings” 26 of the primary layer 16 may change to blue color to indicate that the relevant content related to the user selection is being retrieved. Once the data is retrieved, as shown in FIG. 3, the graphical user interface 10 displays the new data relevant to the user selection.

The secondary layer 18 of the menu structure 12 is then updated to reflect corresponding menu options of the selected menu option of the primary layer 16. By default, a first menu option of the secondary layer 18 is selected. Accordingly, the visual cue 48 provided in the form of the triangular shaped pointer shifts from the “machine parameters” 24 menu option to the “settings” 26 menu option on the primary layer 16, and from the “transmission system” 32 menu option to the “display settings” 50 menu option on the secondary layer 18. In one embodiment, a navigation history of the user may be displayed at a pre-defined location on the graphical user interface 10. Additionally, the previously selected “machine parameters” 26 menu option of the primary layer 16 is restored to a three-dimensional and clickable appearance, while the appearance of the newly selected “settings” 26 menu option is flattened out.

In one embodiment, if the selected content is unavailable, the graphical user interface 10 may return to its previous selection state as shown in FIG. 2. Further, in some embodiments, icons may appear on the interactive menu indications 46 indicating to the user of real-time notifications or availability of updated data since the previous selection by the user.

The graphical user interface 10 illustrated in the accompanying figures is exemplary and does not limit the scope of the present disclosure. The menu options, appearance, and layout thereof on the graphical user interface 10 may vary based on the application.

### INDUSTRIAL APPLICABILITY

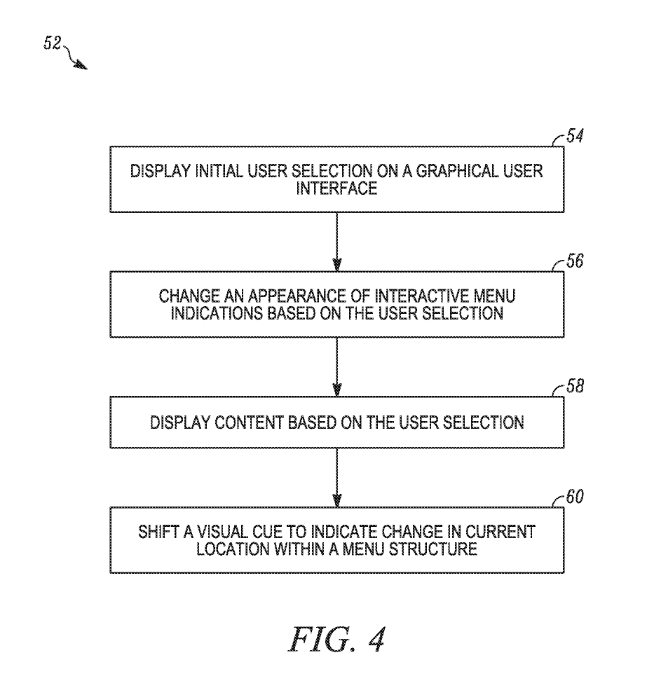

The present disclosure provides the graphical user interface 10. Referring to FIG. 4, a method 52 of navigating the graphical user interface 10 is illustrated. At step 54, the initial user selection is displayed on the graphical user interface 10. At step 56, as the user navigates through the graphical user interface 10, by clicking or touching upon the interactive menu indications 46, the appearance of the interactive menu indications 46 may change to reflect the change in the user selection. For example, the color of the buttons on the graphical user interface 10 may change. At step 58, the new content is displayed corresponding to the user selection. At step 60, the visual cue 48 is relocated on the graphical user interface 10 to indicate the change in the current location of the user within the menu structure 12.

The graphical user interface 10 may be utilized in case of menu structures 12 having up to three layers 14. The graphical user interface 10 provides a simple and intuitive interface for user awareness within nested menu structures 12, allowing the user to understand his current location within the menu structure 12 and providing ease of navigation through the menu structure 12. The graphical user interface 10 provides a visual indication of a navigation path followed by the user to reach the currently displayed content viewable on the touch screen display.

Further, the visual cue 48 provides an indication of a relative location of the displayed content and user selection path with respect to the nested menu structure 12. Each level or layer 14 of navigation of the menu structure 12 is revealed and appropriately maintained based on the user selection. The graphical user interface 10 clearly displays and differentiates between selected and unselected items or menu options, making it easier for the user to interact with the graphical user interface 10. For example, the selected buttons are flattened out to indicate to the user that the user has already and can no longer interact with the given button. Additionally, the visual cue 48 provides a tie of the displayed content with the user selection and current location within the menu structure 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A graphical user interface for a touch display, the graphical user interface comprising:
a menu structure including a plurality of layers; and
a visual cue provided in association with the menu structure, wherein the visual cue provides an indication of a current location of a user selection within the plurality of layers.

2. The graphical user interface of claim 1, wherein the visual cue includes any one of a triangular shaped pointer and a hemi-spherical icon.

3. The graphical user interface of claim 1, wherein the plurality of layers are displayed based on the user selection.

4. The graphical user interface of claim 3, wherein each of the plurality of layers selected for display are positioned in a designated area of the graphical user interface.

5. The graphical user interface of claim 1, wherein each of the plurality of layers further includes interactive menu indications, such that an appearance of the interactive menu indications changes based upon the user selection.
